(19) United States
(12) Patent Application Publication
(10) Pub. No.: US 2023/0297698 A1
(43) Pub. Date: Sep. 21, 2023

(54) TECHNICAL ENVIRONMENT PROTECTION FOR PRIVACY AND COMPLIANCE USING CLIENT SERVER TECHNOLOGY

(71) Applicant: Shashi Kiran Raju Yerra, Fort Mill, SC (US)

(72) Inventor: Shashi Kiran Raju Yerra, Fort Mill, SC (US)

(21) Appl. No.: 17/699,089

(22) Filed: Mar. 19, 2022

(51) Int. Cl. G06F 21/60

(52) U.S. Cl. CPC G06F 21/604

(57) ABSTRACT

The present invention relates to a system, method and computer program product for providing a technical environment for privacy and compliance using client server technology over wired and wireless networks. The ecosystem has a software agent installed on user’s terminal that works as a standalone and networked software which receives instructions from server then perform certain tasks to prevent unintentional or intentional data leakages by hiding the relevant software program and/or its contents. The data may include but not limited to source codes, records, proprietary information, function and application of a particular individual or organization.

### CROSS-REFERENCE TO RELATED APPLICATIONS

This patent application claims the benefit of U.S. Application No. 63/314,506 filed Feb. 28, 2022.

### FIELD OF THE INVENTION

The present invention relates to a system, method and computer program product for providing a technical environment protection for privacy and compliance using client server technology.

### BACKGROUND OF THE INVENTION

Information sharing on wired and wireless networks using screen sharing methods bring many benefits to enterprises due to their scalability and convenience. However, when not managed properly, file sharing can have serious implications from a data security standpoint. File sharing and desktop sharing has grown popularity and frequency as people work remotely and enterprises move to the cloud. However, any time employees use technology to share information between devices, there are security risks involved. Information sharing can introduce risks of malware infection, hacking and loss or exposure of sensitive information. Without proper security measures in place, the benefit of file sharing can be significantly outweighed by the potential for exposing your company’s sensitive data to new security threats. Information sharing is a necessity for today’s enterprises, as employees and business partners become increasingly globalized and require access to electronic documents for increased productivity and collaboration. However, in order to avoid data security risks, enterprises should take the proper steps towards achieving sharing security.

Data security and compliance are major issue for companies of all types and sizes today. Currently, companies require security teams to protect confidential data from targeted attacks and accidental data loss while keeping up with stringent and continuously changing regulations. At the same time, IT teams must adapt to technologies, such as the adoption of cloud computing, mobile apps, and hybrid environments, all of which increase ways through which data can leave your organization. Your organization also has an expanding attack surface, making it a challenge for security teams to protect critical data.

In consideration of the foregoing, enterprises must consider the outburst of data transfer from inside the company to other channels and locations where resides or moves. What’ more, you need to gain visibility and control across all data on-promises and in the cloud, and in various channels such as endpoints, network, web and emails -and what could be better than having a single point of management of such data.

The enterprises have to deploy data loss prevention (DLP) systems to prevent cybersecurity threats and ensure confidential and sensitive information compiles with appropriate regulation. DLP solution prevents data loss, misuse, leakage, or access by malicious actors. In addition, the solution categorizes information into various classifications and identifies policy violations and non compliance with regulations such as CCPA, GDPR, HIPAA, ISO, or PCI DSS.

Enterprises deploy DLP solutions for a wide range of use cases. DLPs are important in the following ways:
DLP systems seek to address data-related threats, such as the risk of unintended or accidental data loss. Some intriguing data loss statistics show that between 40 and 60 percent of businesses won’t reopen after data loss.
DLP provides monitoring, filtering, blocking, and other remediation features to prevent exposure of sensitive data.
Data leakage prevention solution allow administrative control over data governance.
DLP software accelerates compliance in a modern IT environment that faces the daunting challenge of complying with scores of global data security regulations. Besides, the software provides reporting capabilities that accelerate compliance and auditing efforts.
DLP tools enforce remediation to policy violations with alerts, encryption, and other protective actions.

One example of the solution is the network DLP, a gateway-based system that analyzes network traffic to identify unauthorized access and data transmission through channels and protocols like HTTP, HTTPs, IM, FTP, and email. In most cases, network DLP is easy to install, has a low cost ownership cost, and can be dedicated hardware or a software platform installed to run on internet and network connections.

Host-based systems are the second example of DLP solutions enterprises install on end-user servers or computers to manage data flow between users and groups. The solution can also control email communications before keeping them in the company archives. Host-based DLP does not operate on data in transit. Instead, organizations install the solution on individual devices to monitor data at rest or moving into the endpoints, regardless of where or how the device is connected to the network or internet.

An email data loss prevention system protects users against insider threats and unintentional data loss through emails. The system monitors information shared via email to detect and block suspicious activities that potentially lead to data loss. It contain predefined mail flow rules that can and filter both attachments and messages to identify text patterns and keywords for sensitive information to prevent risks like misattached files or misdirected emails.

Undoubtly, organizations face more security risks and rigorous data privacy requirements when expanding their IT use to include cloud computing. Overall, cloud services are exposed to threats that increase the demand for a cloud DLP solution. A Cloud DLP system offers visibility and protects sensitive information in cloud environments. In this case, the solution keeps Saas, Paas, and laaS applications and information sale from insider threats, data breaches, and inadvertent exposures.

What data do your organization store and share? How much of this information is classified as sensitive and may be at risk of leakage? Storage DLP addresses these issues. The solution allows enterprises to view confidential files stored and shared by authorized users. That way, users can identify critical points and prevent data leakage.The storage DLP system works for both on-premise and cloud storage infrastructure.

By design, an effective DLP should provide distribution control that prevents companies from sharing sensitive data with the public and insecure networks. In this case, the solution controls data on endpoints to enforce security and data privacy policies across the organization. Overall, DLP provides data protection and prevents leaks by internal sources.

However, DLP software still lacks some security features like what if a user shares PII, PHI, government, or confidential data to an “unauthorized person” over a screen-sharing software - which can be recorded, captured, and translated to text using OCR? Typically, some types of customer service activities, such as IT support, can be difficult to handle over the phone or email. In such a case, it is effective for a customer support agent to show users what is going on using screen sharing. Remote screens sharing software, however, has some security disadvantages. Other times, an outsourced support service representative can view, record, or screenshot confidential information displayed on the screen while providing remote customer support. A malicious person can also do shoulder-surfing when an authorized representative is connected on a remote/screen sharing to his company from public places.

Advanced malware can sometimes reach user systems and target screen sharing programs by taking screenshots or recording screens and transferring the information to a malicious user. For instance, the malware XCSSET can take screenshots of users computer, compromising their personal information, including credit card numbers, addresses, passwords, and more.

Screen recording tools allow users to record their screens and save the video files in different file formats and locations. Such application may seem legitimate and useful, but they may be malicious apps often installed to collect data. The truth is that when you use online screen recording services, the providers uploads the recording file to their cloud server, which can leak sensitive information.

What about video conferencing tools? With more organizations likely to permanenly adopt a remote-first workstyle, confidential meetings over video conference tools like zoom, hangouts, and microsoft teams expose confidential and protected data through employee screen sharing and presentations. Such image files ripe for data exfiltration Unfortunately, they represent a security need in which legacy DLP tools are limited and, in some cases, entirely blind.

The present invention proposes a cloud-based (SaaS) and artificial intelligence based DLP solution that is easily deployable and manageable. Characteristically, this enhanced DLP solution can be deployed in private networks and endpoints and the solution runs in the background to protect users when sharing screens.

### SUMMARY OF THE INVENTION

The present invention generally relates to an ecosystem for enabling privacy and protection of data and information shared over wired and wireless networks. The ecosystem has a software agent that works as a standalone or a networked software which receives instructions from server then perform certain tasks to prevent unintentional or intentional data exposure. Data includes source codes, records, or any information that is a property of the given organization.

In an embodiment of the present invention, every company has its own administrators and is able to request or generate an agent or service that will get installed in their user computers. The agent is configured to perform actions given by system administrator to display or hide the software application or data when it is shared using desktop or screen sharing methods.

In an embodiment of the present invention, a SaaS based and artificial intelligence based DLP solution is disclosed that is easily deployable and manageable. It is a lightweight software that combines the zero-trust principle and machine learning to detect illegal data extrafiltration and provide advanced threat detection.

The DLP solution disclosed here can be deployed in private networks and endpoints. Better still, users will not see any changes in computer speed after installing the service or agent.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

### BRIEF DESCRIPTION OF THE ACCOMPANYING DRAWINGS

The aforesaid as well as other objects and advantages of the invention will appear hereinafter from the following description taken in connection with the accompanying drawings in which:

FIG. 1 illustrates an exemplary embodiment of a system connecting different users over a network;

FIG. 2 illustrates an exemplary embodiment of an ecosystem enabling privacy and protection of data and information shared over wired and wireless networks; and

FIG. 3 illustrates an exemplary system implementing various embodiments of the present invention.

### DETAILED DESCRIPTION OF THE INVENTION

Additional features and advantages of the invention will be set forth in the description which follows, and in part will be obvious from the description, or may be learned by the practice of the invention. These and other features of the present invention will become more fully apparent from the following description, or may be learned by the practice of the invention as set forth hereinafter.

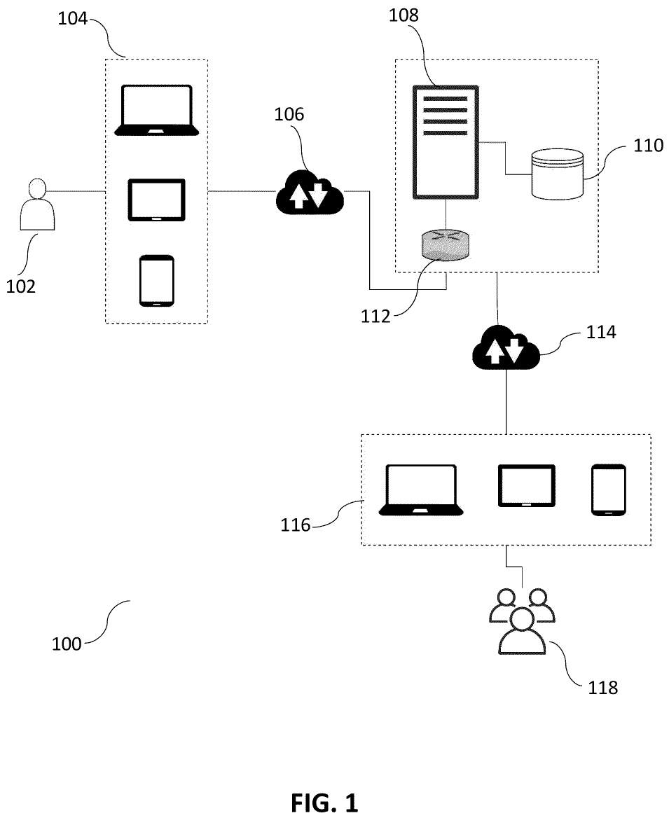

With reference now to the drawings, and in particular to FIG. 1 to FIG. 3 hereof, a system, method and computer program product for enabling privacy and protection of data and information over network embodying the principles and concepts of the present invention is described.

Reference is made now to FIG. 1, illustrating an embodiment 100 of present invention comprising a first user 102 of interacting with user terminal 104 which may include but not limited to computer, laptop, smartphone etc. communicatively coupled to server 108 via internet 106 through a communication gateway 112. The server 108 is configured to access and edit data to database 110. The second user 118 interacting with user terminal 116 connects to server 108 via communication gateway 112. This system allows the users of first company and second company to communicate and share their information over the network.

The present invention is a cloud-based (SaaS) solution that is easily deployable and manageable. Characteristically, the process features automation that makes the service or agent adoption intuitive and frictionless. That way, the use of the solution does not get in the way of business productivity.

The agent or service is a lightweight computer program product that combine the zero-trust principle and machine learning to detect illegal data exfiltration and provide advanced threat detect illegal data filtration and provide advanced threat detection. It is a highly customizable tool featuring granular controls that allow the user to fine-tune responses based on various factors, including users or risk levels.

In an embodiment of the present invention, the agent or service provides desktop content protection. It supports and meets several security standards and frameworks, including LGPD, ADPR (Australia), CCPA, GDPR, GLBA, HIPPA, HITRUST, ISO 27001, NIST, PCI DSS, PDPA (Singapore), PIPEDA (Canada), POPI, and SOX.

The agent or service can also be deployed in private networks and endpoints. It is a lightweight program that runs in background to protect users while sharing screens.

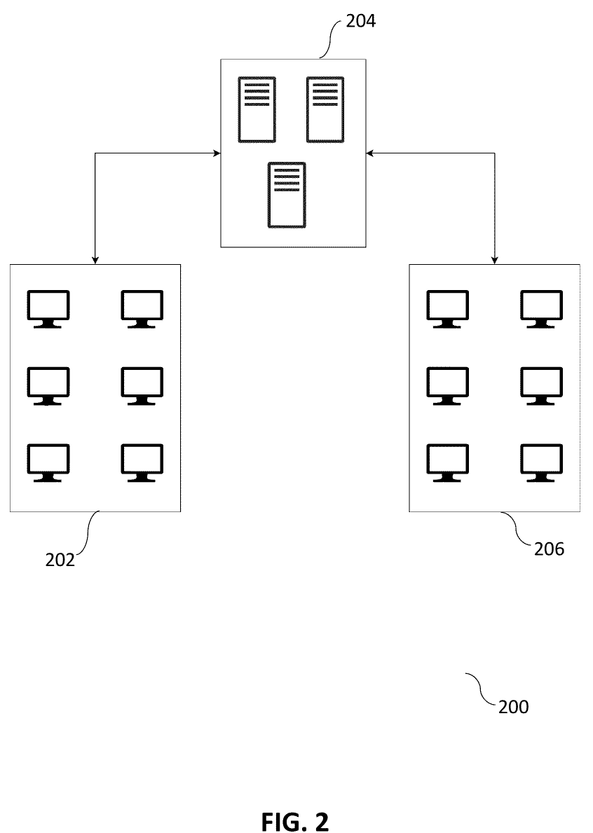

Reference is made now to FIG. 2, illustrating an embodiment 200 of the present invention comprising a set of terminals in first company 202 connected to each other through a local area network. This network of terminals is further connected to a multitenant service 204 hosted in cloud. Similarly, a set of interconnected terminals in second company 206 is connected to the multitenant service 204 hosted in cloud for second company. Each company has its own administrator generating and managing an agent or service that is installed in user terminals configured to display or hide data, information, functions, or applications using certain business logic upon receiving instructions from the server.

In an alternative embodiment, the service or agent performing display and hide functions may be deployed at individual level instead of company level following peer to peer architecture through a wired or wireless network.

In an embodiment of the present invention, the service or agent protects against unauthorized screen sharing of protected applications and data. The invention supports companies tackling compliance needs. Alongside that, the service or agent protects sensitive information by enabling them to extend contextual and granular data protection policies to screen-sharing.

The service or agent can prevent screenshot images of protected applications to mitigate the loss of sensitive-borne information. That way, enterprises can effectively and immediately identify sensitive data in screenshot, video, and static images before malicious actors or unsuspecting employees ex-filtrate it.

The service or agent reduces data loss risk at most vulnerable points of risk -endpoints by hiding critical applications from malware, malicious users, remote help desks, and other threat actors. As a result, enterprises can rely on the agent or service to protect their IP, personal information, and confidential corporate data. They can design and implement policies and control that won’t block transactions that comply with the corporate policies to ensure that employees remain productive while data stays secure. In addition, the service or agent has unique contextual awareness capabilities that automatically blocks transactions that pose a threat to an organization.

With existing DLP solutions still having missing pieces, the SaaS based and artificial intelligence based DLP service or agent disclosed above provides companies the broadest control and coverage, with the current version supporting various operating systems. In addition, the DLP solution disclosed here does not make coverage compromises or leave gaps in data protection strategy even in hybrid environments. Finally, the comprehensive data loss prevention software prevents potential hackers, insider threats, and data theft by detection actions like data copy and screenshot attempts that may result in data loss.

In various embodiments, the invention additionally comprises a computer program product comprising a non-transitory computer readable medium having a computer readable program code embodiment therein – said computer readable program code comprising instructions for implementation of any of the method embodiments described above.

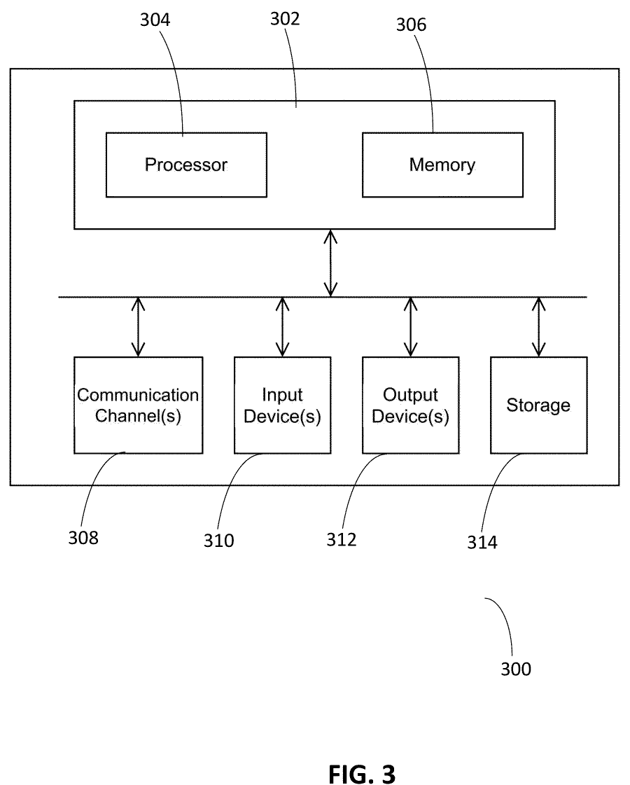

FIG. 3 illustrates an exemplary system 300 for implementing the present invention

Computer system 302 comprises one or more processors 304 and at least one memory 306. Processor 304 is configured to execute program instructions - and may be a real processor or a virtual processor. It will be understood that computer system 302 does not suggest any limitation as to scope of use or functionality of described embodiments. The computer system 302 may include, but is not be limited to, one or more of a general-purpose computer, a programmed microprocessor, a micro-controller, an integrated circuit, and other devices or arrangements of devices that are capable of implementing the steps that constitute the methods of the present invention. Exemplary embodiments of a computer system 302 in accordance with the present invention may include one or more servers, desktops, laptops, tablets, smart phones, mobile phones, mobile communication devices, tablets, phablets and personal digital assistants. In an embodiment of the present invention, the memory 306 may store software for implementing various embodiments of the present invention. The computer system 302 may have additional components. For example, the computer system 302 may include one or more communication channels 308, one or more input devices 310, one or more output devices 312, and storage 314. An interconnection mechanism (not shown) such as a bus, controller, or network, interconnects the components of the computer system 302. In various embodiments of the present invention, operating system software (not shown) provides an operating environment for various software(s) executing in the computer system 302 using a processor 304, and manages different functionalities of the components of the computer system 302.

The communication channel(s) 308 allow communication over a communication medium to various other computing entities. The communication medium provides information such as program instructions, or other data in a communication media. The communication media includes, but is not limited to, wired or wireless methodologies implemented with an electrical, optical, RF, infrared, acoustic, microwave, Bluetooth or other transmission media.

The input device(s) 310 may include, but is not limited to, a touch screen, a keyboard, mouse, pen, joystick, trackball, a voice device, a scanning device, or any another device that is capable of providing input to the computer system 302. In an embodiment of the present invention, the input device(s) 310 may be a sound card or similar device that accepts audio input in analog or digital form. The output device(s) 312 may include, but not be limited to, a user interface on CRT, LCD, LED display, or any other display associated with any of servers, desktops, laptops, tablets, smart phones, mobile phones, mobile communication devices, tablets, phablets and personal digital assistants, printer, speaker, CD/DVD writer, or any other device that provides output from the computer system 302.

The storage 314 may include, but not be limited to, magnetic disks, magnetic tapes, CD-ROMs, CD-RWs, DVDs, any types of computer memory, magnetic stripes, smart cards, printed barcodes or any other transitory or non-transitory medium which can be used to store information and can be accessed by the computer system 302. In various embodiments of the present invention, the storage 314 may contain program instructions for implementing any of the described embodiments.

In an embodiment of the present invention, the computer system 302 is part of a distributed network or a part of a set of available cloud resources.

The present invention may be implemented in numerous ways including as a system, a method, or a computer program product such as a computer readable storage medium or a computer network wherein programming instructions are communicated from a remote location.

The present invention may suitably be embodied as a computer program product for use with the computer system 302. The method described herein is typically implemented as a computer program product, comprising a set of program instructions that is executed by the computer system 302 or any other similar device. The set of program instructions may be a series of computer readable codes stored on a tangible medium, such as a computer readable storage medium (storage 314), for example, diskette, CD-ROM, ROM, flash drives or hard disk, or transmittable to the computer system 302, via a modem or other interface device, over either a tangible medium, including but not limited to optical or analogue communications channel(s) 308. The implementation of the invention as a computer program product may be in an intangible form using wireless techniques, including but not limited to microwave, infrared, Bluetooth or other transmission techniques. These instructions can be preloaded into a system or recorded on a storage medium such as a CD-ROM, or made available for downloading over a network such as the Internet or a mobile telephone network. The series of computer readable instructions may embody all or part of the functionality previously described herein.

While the exemplary embodiments of the present invention are described and illustrated herein, it will be appreciated that they are merely illustrative. It will be understood by those skilled in the art that various modifications in form and detail may be made therein without departing from or offending the spirit and scope of the invention as defined by the appended claims. Additionally, the invention illustratively disclosed herein suitably may be practiced in the absence of any element which is not specifically disclosed herein - and in particular embodiment specifically contemplated, is intended to be practiced in the absence of any element which is not specifically disclosed herein.

1. A system for providing a technical environment protection for privacy and compliance using client server technology wherein first terminal is connected to one or more terminals over a wired or wireless network and the terminals are managed by administrator using a central computer or a website for deploying a customized agent and/or service that is installed in first user terminal that is configured to display or hide data, information, source code, function or applications using a business logic upon receiving instruction from the server.

2. A system according to claim 1, wherein the agent or service is cloud-based data loss prevention solution that is configured with machine learning algorithms for illegal data ex-filtration and provide advanced threat detection.

3. A system according to claim 1, wherein agent or service is highly customizable with granular controls that allow the user to fine-tune responses based on various factors, including users or risk levels.

4. A system according to claim 1, wherein the agent or service provides desktop content protection.

5. A system according to claim 1, wherein the agent or service can be deployed in private networks and endpoints executing as background process in operating systems of terminals to protect users while sharing screens.

6. A system according to claim 1, wherein the agent or service protects against unauthorized screen sharing of protected applications and data by enabling user to extend contextual and granular data protection policies to screen sharing.

7. A system according to claim 1, wherein the agent or service prevent screenshot images of protected application to mitigate the loss of sensitive screenshot-borne information.

8. A system according to claim 1, wherein the agent or service reduces data loss risk at vulnerable points by hiding critical applications from malware, malicious users, remote help desks, and other threat actors.

9. A system according to claim 1, wherein the agent or service has unique contextual awareness capabilities that automatically block transactions that pose a threat to an organization.

10. A method for providing a technical environment protection for privacy and compliance using client server technology wherein first terminal is connected to one or more terminals over a wired or wireless network and the terminals are managed by administrator using a central computer or a website for deploying a customized agent and/or service that is installed in first user terminal that is configured to display or hide data, information, source code, function or applications using a business logic upon receiving instruction from the server.

11. A computer program product for providing a technical environment protection for privacy and compliance using client server technology wherein first terminal is connected to one or more terminals over a wired or wireless network and the terminals are managed by administrator using a central computer or a website for deploying a customized agent and/or service that is installed in first user terminal that is configured to display or hide data, information, source code, function or applications using a business logic upon receiving instruction from the server.
